(19) United States
(12) Patent Application Publication
(10) Pub. No.: US 2008/0147542 A1
(43) Pub. Date: Jun. 19, 2008

(54) System And Method For Efficient Allocation Of Charitable Donations

(76) Inventors: Matthew James Dunlop, Pickerington, OH (US); Benjamin James Dunlop, Columbus, OH (US)

Correspondence Address: RONALD J. KOCH, 698 MORRISON RD., SUITE B, COLUMBUS, OH, 43213, US

(21) Appl. No.: 11/956,217

(22) Filed: Dec. 13, 2007

Related U.S. Application Data
(60) Provisional application No. 60/869,783, filed on Dec. 13, 2006.
(60) Provisional application No. 60/944,173, filed on Jun. 15, 2007.

(51) Int. Cl. G06Q 40/00

(52) U.S. Cl. 705/39

(57) ABSTRACT

A system and method for efficient allocation of charitable contributions comprises client system 100 having web browser 110; server system 200 having web pages 210, server engine 220, and databases 230; whereby a user purchases product 300 and thereafter logs on to server system 310 which receives input of product identifier 320, displays information about product 330, displays interactive donee list/allocation forms 340, receives input of user selection 350, and initiates funds disbursement 360.

The present application is related to the co-pending provisional patent application No. 60/869,783 of Matthew James Dunlop, et al, filed Dec. 13, 2006, entitled “System And Method For Efficient Allocation Of Charitable Donations”, and based on which priority is herewith claimed under 35 U.S.C. 119(e) and the disclosure of which is incorporated herein by reference in its entirety as if fully rewritten herein.

The present application is related to the co-pending provisional patent application No. 60/944,173 of Matthew James Dunlop, et al, filed Jun. 15, 2007, entitled “System And Method For Efficient Allocation Of Rebates”, and based on which priority is herewith claimed under 35 U.S.C. 119(e) and the disclosure of which is incorporated herein by reference in its entirety as if fully rewritten herein.

### BACKGROUND AND SUMMARY

The present invention relates generally to charitable contributions and specifically to systems and methods of facilitating such contributions by virtue of a web-based interface.

The present invention is in the field of facilitation, division, and transfer of charitable monetary contributions to singular or multiple nonprofit organizations associated with the purchase of individual or singular consumer products through input of product codes, product serial numbers, or other identifiers into the internet (or successor) site.

Currently, people purchase consumer products (goods) that are sometimes affiliated or cross promoted by a charitable organization. A portion of the funds from the sale of the product are then donated or directed to the charitable organization. Therefore, buyers are forced to make contributions by default. If they buy a product to which there is a donation established, the funds are diverted beyond their control.

People wishing to contribute to specific organizations not promoted by their “favored” products must make individual donations separate from any produce or product purchases. i.e. They must contribute using additional funds to the organizations of their choosing. The present invention will empower people to more easily control contributions made and increase their individual purchase power.

Oftentimes, the product producer and charitable organization have a pre-existing relationship. An example of such a relationship comprises a soup company establishing a relationship with a charitable organization that supports breast cancer awareness, research, and development. The parties agree that a portion of the revenue generated by the purchase of each can of soup goes to the charity. The cans are specially marked with a pink label and a pink ribbon (it is widely known that the color pink as well as pink ribbons are associated with breast cancer) displaced thereon. The consumer may or may not choose the soup because of the label. i.e. the special promotion may be incidental to the purchase. This process has several disadvantages that are common to the conventional methods of diverting sales proceeds to charitable organizations.

One disadvantage is that the consumer has no control over the amount given to the charity and cannot choose the charity. There currently exists no method for the consumer making the purchase to directly influence the use of the donated funds in this way.

The present invention overcomes this limitation by enabling the purchaser to directly influence the process by having them interact with an internet web site where they can then direct and control the use of contributed funds for single or multiple non-profit organizations.

The present invention enables more efficient philanthropy. It enables direct influence of the charitable donation process through entry of product codes (herein, also known as “identifiers”) from participating consumer goods into an internet web site where funds can then be directed and controlled for the benefit of single or multiple nonprofit organizations.

One preferred embodiment comprises a product manufacturer establishing a relationship with a charitable organization. The parties agree to divert funds from the purchase of given goods to a given charity. The parties also agree to facilitate this by utilizing the present invention. It is envisioned that a third company, the host company, maintains the internet web site and necessary means of implementing the invention. However, this is not necessary. The product manufacturer or charitable organization can fulfill this role. The necessary means of implementing the invention comprise providing a computer database, internet server, a computer processor and memory that allow a user to input information sufficient to direct funds from the goods purchased to the charitable organization.

Thereafter, the goods are marked with an identifying code sufficient to link the product with the charity according to predetermined directives. The goods are also marked with sufficient identifying information to direct the purchaser of the goods to an internet website. The goods are then placed for sale. It is envisioned that the host company will develop sufficient good will that the public will already be aware of it and will recognize some or all of the identifying information of the goods. Thus, consumer brands supporting the logo (website url of host company), etc may be favored over competing brands. However, this is not necessary—only preferred.

The goods are purchased. The buyer, being aware of the charitable aspect of the purchase, either before or incidental to the purchase, establishes contact with an internet server. The buyer is then directed to input identifying information from the purchased goods. It is envisioned that the buyer will also be directed to input additional information such as demographic information. However, this is not necessary. The buyer is then presented with various options for directing proceeds from the sale of the goods to a charity or multiple charities featured.

The options presented to the buyer are decided by any combination of the product manufacturer, charitable organization, and host company. It is understood that myriad options are available and that the options presented herein are nonexclusive, other options will be apparent to those of skill in the art. These options generally comprise: The buyer may allocate the available funds between one or more charities; the buyer may direct that no funds be disbursed at all; the buyer may decide to add additional funds from a credit card or other funding source; the buyer may nominate a charity not previously listed. Whereby funds received from the purchase of goods may be diverted to charities.

It is understood that the terms “identifying code” and “identifying information” are defined, in addition to ordinary dictionary meaning and those meanings known within the art, as any combination of numerical, textual, and/or graphical information or symbols that allow information to be recorded in a meaningful manner.

The synergy produced by the present invention may be utilized in various ways. Namely, the general public will have knowledge of an organization that utilized the present invention. They may then interact with the internet server and contribute funds to charities without even buying a product.

There are other advantages to the present invention. The consumer interaction with the internet web site can be recorded, monitored, and analyzed. Thus, market intelligence is gained. This knowledge can be taken advantage of. Other advantages comprise providing search functions for charitable organizations, historical tracking to show past donations, reporting functions for income tax credits, etc.

The present invention is also advantageous because it allows nearly simultaneous matching of goods to charities. For example, a natural disaster, such as a hurricane, occurs. The host company has pre-existing directives from product manufacturers and/or charitable organizations that allow funds to be diverted in such an event. Funds from goods purchased before and after the disaster can therefore be directed the new charities. The buyer establishes contact with the internet server and is presented with additional choices that would not exist had the disaster not occurred. Moreover, funds can be placed in trust in contemplation of a new charity being created specific to the disaster. E.g. “the hurricane [name] fund” then the funds would be disbursed upon creation of the charity. Other objects and advantages of the present invention will be apparent to those of skill in the art.

As will be apparent to those of skill in the art, various database configurations can be used to match the product identifiers with pre-established and newly entered donees and to store information relative to the user directed allocation of funds and to store information relative to each user. The user information can be helpful to facilitate subsequent donations by the same user; the user can be provided with information indicative of past donations, etc.

In addition to use with individual product purchases, the invention can also be utilized by a seller of goods and/or services (e.g. retailer) for an entire purchase event. For example, 2% of the total grocery purchase at a super market can be established to go towards a charitable contribution.

In this example, a promotion code (identifier) would be printed on the sales receipt (but could be printed on a separate paper, tag, etc.) as opposed to being marked on the product. The user would allocate this amount among one or more donees as with the other embodiments.

It is to be understood that the definition of the term “purchase” includes “retail sales transaction”, and the term “seller” includes “retailer” in addition to ordinary and dictionary definitions. It is also to be understood that the roles of retailer and product producer can be used interchangeably.

### BRIEF DESCRIPTION OF THE DRAWINGS

FIG. 1 depicts a block diagram illustrating one embodiment of the present invention

FIG. 2 depicts a flow diagram of one embodiment of the present invention

FIG. 3 depicts a block diagram illustrating one embodiment of the present invention

FIG. 4 depicts a flow diagram of one embodiment of the present invention

FIG. 5 depicts a block diagram of a product in accordance with the invention

FIG. 6 depicts a block diagram illustrating one embodiment of the present invention

FIG. 7 depicts a flow diagram of one embodiment of the present invention

FIG. 8 depicts a block diagram illustrating one embodiment of the present invention

FIG. 9 depicts a flow diagram of one embodiment of the present invention

### DETAILED DESCRIPTION

The present invention provides a system and method for efficient allocation of charitable contributions. One embodiment comprises the steps of:

Providing a server computer system capable of electronic communication (It is to be understood that the term “electronic communication” includes a user controlling a client system logging on to a server system through a network or internet, wireless device, or wireless network, or telephonic system) with a user in control of a client system;

Enabling the user to selectively allocate a portion of the purchase price of a product (It is to be understood that the term “product” includes consumer goods—as will be apparent to those of skill in the art, such goods can include food, electronics, clothing, or any tangible object purchased that can be marked with sufficient identifying information to implement the invention) among one or more donees;

The portion of the purchase price of a product can be pre-established (but does not have to be) and agreed to by the seller of the good and the entity that performs the invention (as will be apparent to those of skill in the art, distinct entities are not necessary but rather the arrangement contemplated by the inventors);

The product is marked with an identifier (such as a bar code, alphabetical or numerical information promotional code, chemical, optical, or biometric tag); the product can also be (but does not have to be) marked with an invitation sufficient to invite a user (e.g. A purchaser of the product marked) to allocate a pre-established portion of the purchase price of the product among any number of donees; the inventors contemplate that such an invitation could be an url listing or other internet web site indicator or alternatively an interactive telephonic system; the one or more donees can be selected from a pre-established list and/or identified by the user;

In addition to monies allocated from the purchase price of the product, the user can add additional funds (e.g. Utilizing a credit card) to be disbursed among one or more donees; the selective allocation and the product identifier are recorded and saved by the server system (this data can be shared with the seller of the products or other entities involved, and has other benefits such as market research, etc.);

The system then initiates or facilitates the disbursement of funds in accordance with the user's directives (as will be apparent to those of skill in the art, this can be accomplished by interaction with a separate payment system or integrated into the invention).

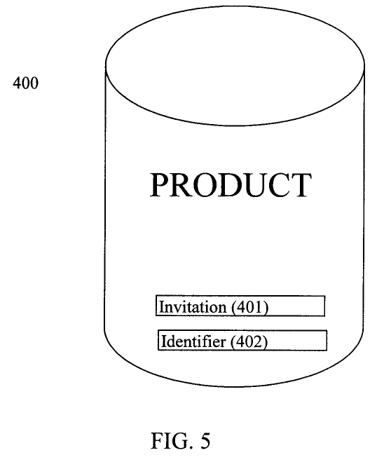

FIG. 5 illustrates a typical product contemplated by the inventors in the various embodiments presented wherein product 400, has marked thereon invitation 401, and identifier 402.

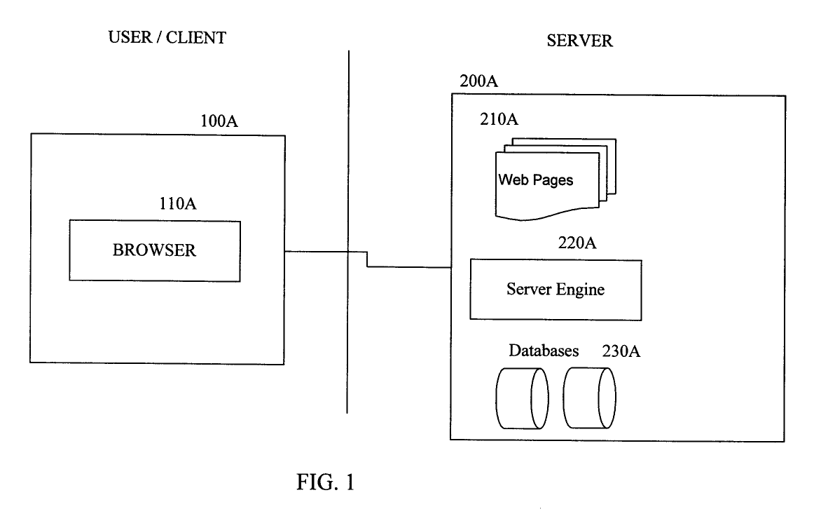

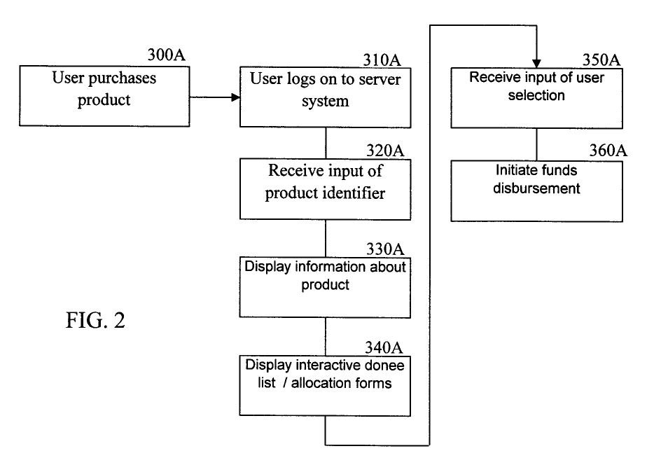

FIGS. 1 and 2 illustrate one embodiment of the present invention. Client system 100A comprises web browser 110A. As will be apparent to those of skill in the art, client system 100A can be a conventional personal computer with internet access.

Server system 200A comprises web pages 210A, server engine 220A, and databases 230A. As will be apparent to those of skill in the art, various database configurations can be used to match the product identifiers with pre-established and newly entered donees and to store information relative to the user directed allocation of funds and to store information relative to each user.

In operation, a user purchases 300A a product 400 and thereafter logs on 310A to the server system 200A which receives input 320A from the user relating to the product identifier 402. The server system 200A retrieves information matched to the product identifier 402 and displays 330A information about product 400 as well as interactive donee list/allocation forms 340A. As will be apparent to those of skill in the art, various interactive forms can be used so long as the user may view necessary information and allocate percentages of available funds among chosen donees.

Upon receiving input of user selection 350A, the server system 200A initiates funds disbursement 360A in accordance with the user's directives.

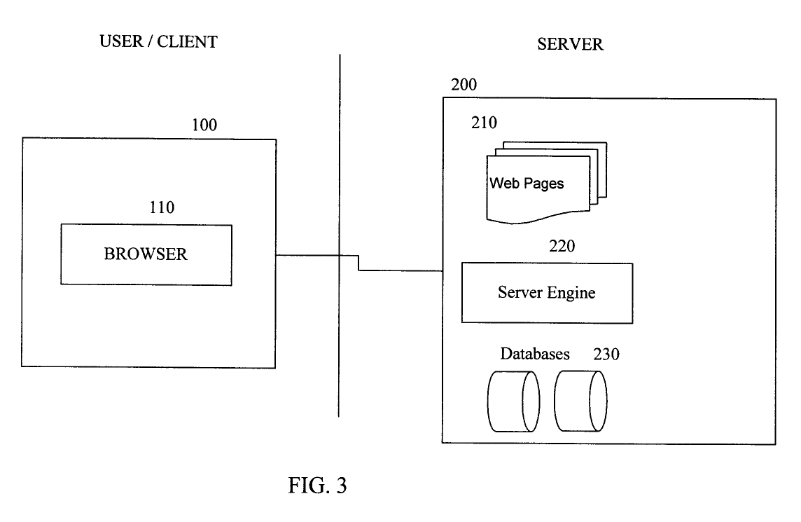

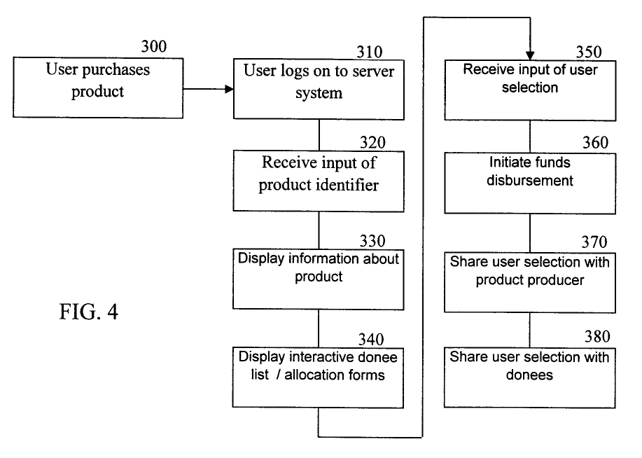

FIGS. 3 and 4 illustrate one embodiment of the present invention wherein client system 100 comprises web browser 110; server system 200 comprises web pages 210, server engine 220, and databases 230.

The configuration and operation of the embodiment presented in FIGS. 3 and 4 is analogous to the embodiment presented in FIGS. 1 and 2, except that the additional steps of sharing information about the user directives are added. The information is shared with product producer 370 and donees 380.

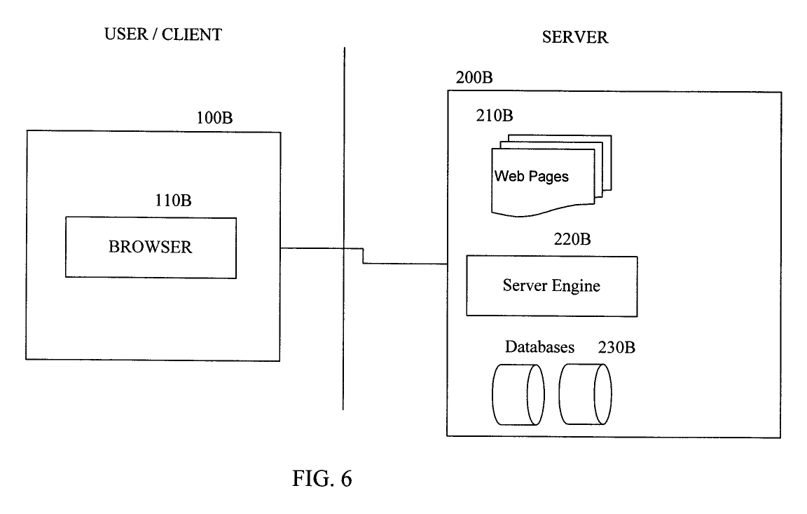

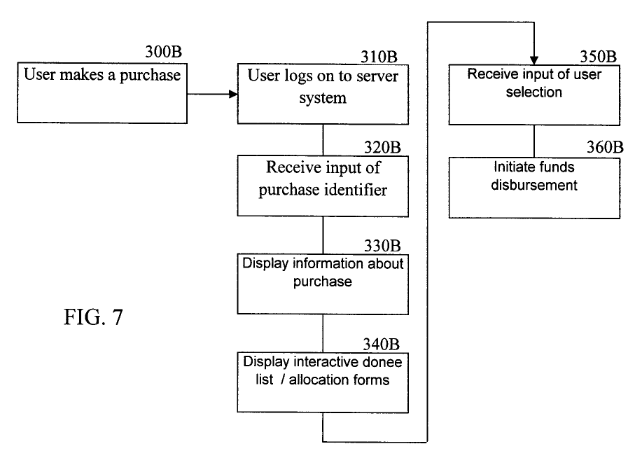

FIGS. 6 and 7 illustrate one embodiment of the present invention. Client system 100B comprises web browser 110B. As will be apparent to those of skill in the art, client system 100B can be a conventional personal computer with internet access.

Server system 200B comprises web pages 210B, server engine 220B, and databases 230B. As will be apparent to those of skill in the art, various database configurations can be used to match the identifiers with pre-established and newly entered donees and to store information relative to the user directed allocation of funds and to store information relative to each user.

In operation, a user makes a purchase 300B. The purchase can comprise a service and/or one or more products. An identifier is marked on a receipt (or other paper, tag, etc.). The identifier is associated with the purchase. Thereafter, the user logs on 310B to the server system 200B which receives input 320B from the user relating to the purchase identifier. The server system 200B retrieves information matched to the identifier and displays 330B information about the purchase as well as interactive donee list/allocation forms 340B. As will be apparent to those of skill in the art, various interactive forms can be used so long as the user may view necessary information and allocate percentages of available funds among chosen donees.

Upon receiving input of user selection 350B, the server system 200B initiates funds disbursement 360B in accordance with the user's directives.

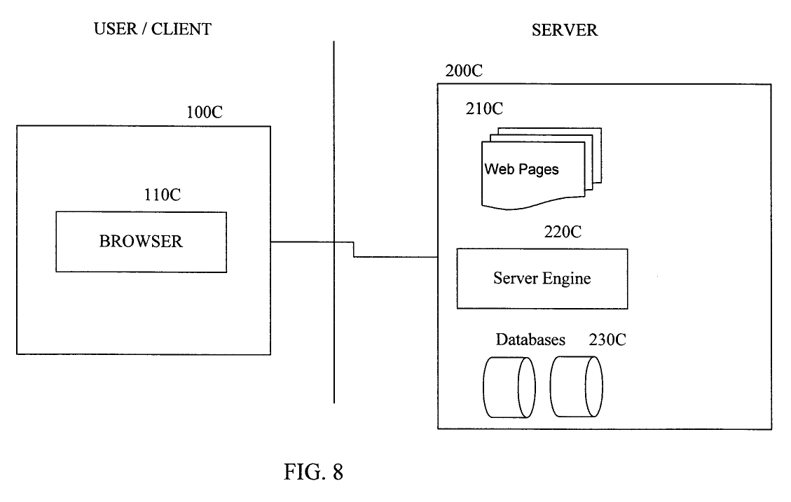

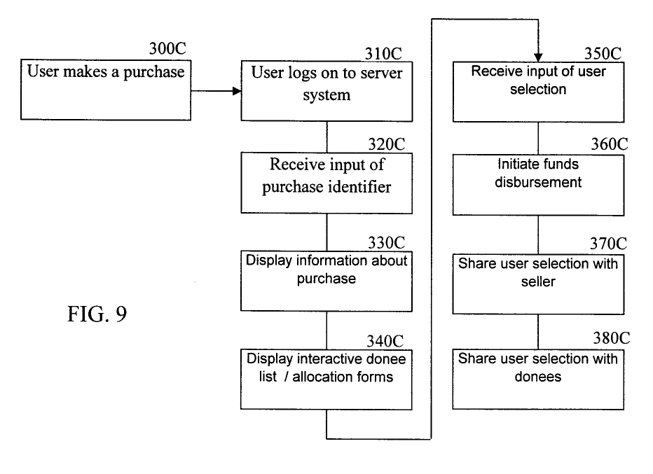

FIGS. 8 and 9 illustrate one embodiment of the present invention wherein client system 100C comprises web browser 110C; server system 200C comprises web pages 210C, server engine 220C, and databases 230C.

The configuration and operation of the embodiment presented in FIGS. 8 and 9 is analogous to the embodiment presented in FIGS. 6 and 7, except that the additional steps of sharing information about the user directives are added. The information is shared with the seller 370C and donees 380C.

What is claimed is:

1. A method for efficient allocation of charitable contributions comprising the steps of:
providing a server computer system capable of electronic communication with a user in control of a client system;
enabling said user to selectively allocate a portion of the purchase price of a product among one or more donees;
said product being marked with an identifier;
initiating a funds disbursement according to said user selection;
whereby the purchaser of goods allocates charitable contributions incidental to the purchase of goods.

2. The method of claim 1 further comprising:
said portion of the purchase price of a product being pre-established.

3. The method of claim 1 further comprising:
said identifier being a bar code.

4. The method of claim 1 further comprising:
said product being marked with an invitation sufficient to invite a user to allocate a pre-established portion of the purchase price of said product among any number of donees.

5. The method of claim 4 further comprising:
said invitation comprising directing said user to an electronic interactive medium.

6. The method of claim 1 further comprising:
said one or more donees being selected from a pre-established list.

7. The method of claim 1 further comprising:
said one or more donees being selected by said user.

8. The method of claim 1 further comprising:
enabling said user to add additional funds to be disbursed among one or more donees.

9. The method of claim 8 further comprising:
said additional funds originating from a credit card transaction.

10. The method of claim 1 further comprising:
recording said user selection along with said identifier.

11. The method of claim 1 further comprising:
sharing said user selection with the producer of said product.

12. The method of claim 1 further comprising:
sharing said user selection with donees chosen by said user.

13. The method of claim 1 further comprising:
sharing said user selection with donees on a pre-established list.

14. A system for efficient allocation of charitable contributions comprising:
a server computer system capable of electronic communication with a user in control of a client system;
said server computer system having a computer processor and memory sufficient to enable said server computer system to perform the steps of,
enabling said user to selectively allocate a portion of the purchase price of a product among one or more donees,
said product being marked with an identifier,
initiating a funds disbursement according to said user selection;
whereby the purchaser of goods allocates charitable contributions incidental to the purchase of goods.

15. The system of claim 14 further comprising:
said portion of the purchase price of a product being pre-established.

16. The system of claim 14 further comprising:
said identifier being a bar code.

17. The system of claim 14 further comprising:
said product being marked with an invitation sufficient to invite a user to allocate a pre-established portion of the purchase price of said product among any number of donees.

18. The system of claim 17 further comprising:
said invitation comprising directing said user to an electronic interactive medium.

19. The system of claim 14 further comprising:
said one or more donees being selected from a pre-established list.

20. The system of claim 14 further comprising:
said one or more donees being selected by said user.

21. The system of claim 14 further comprising:
said server computer system having a computer processor and memory sufficient to enable said server computer system to perform the step of enabling said user to add additional funds to be disbursed among one or more donees.

22. The system of claim 21 further comprising:
said additional funds originating from a credit card transaction.

23. The system of claim 14 further comprising:
said server computer system having a computer processor and memory sufficient to enable said server computer system to perform the step of recording said user selection along with said identifier.

24. The system of claim 14 further comprising:
said server computer system having a computer processor and memory sufficient to enable said server computer system to perform the step of sharing said user selection with the producer of said product.

25. The system of claim 14 further comprising:
said server computer system having a computer processor and memory sufficient to enable said server computer system to perform the step of sharing said user selection with donees chosen by said user.

26. The system of claim 14 further comprising:
said server computer system having a computer processor and memory sufficient to enable said server computer system to perform the step of sharing said user selection with donees on said pre-established list.

27. A method for efficient allocation of charitable contributions comprising the steps of:
providing a server computer system capable of electronic communication with a user in control of a client system;
providing an identifier to said user, said identifier being associated with a purchase;
enabling said user to selectively allocate a portion of said purchase among one or more donees;
initiating a funds disbursement according to said user selection;
whereby a user allocates charitable contributions incidental to a purchase.

28. The method of claim 27 further comprising:
said portion of said purchase being pre-established.

29. The method of claim 27 further comprising:
said identifier being marked on a receipt.

30. The method of claim 27 further comprising:
said one or more donees being selected from a pre-established list.

31. The method of claim 27 further comprising:
said one or more donees being selected by said user.

32. The method of claim 27 further comprising:
enabling said user to add additional funds to be disbursed among one or more donees.

33. The method of claim 32 further comprising:
said additional funds originating from a credit card transaction.

34. The method of claim 27 further comprising:
recording said user selection along with said identifier.

35. The method of claim 27 further comprising:
sharing said user selection with a seller.

36. The method of claim 27 further comprising:
sharing said user selection with donees chosen by said user.

37. The method of claim 27 further comprising:
sharing said user selection with donees on a pre-established list.

38. The method of claim 27 further comprising:
said purchase comprising the purchase of one or more goods.

39. The method of claim 27 further comprising:
said purchase comprising the purchase of a service.
